(19) United States
(12) Patent Application Publication
(10) Pub. No.: US 2010/0332140 A1
(43) Pub. Date: Dec. 30, 2010

(54) METHOD OF ASSESSING THE EATING EXPERIENCE OF A COMPANION ANIMAL

(76) Inventors: Jonathan Livingston Joyce, Independence, KY (US); Charles Thomas Goubeaux, West Manchester, OH (US); Kelly Stewart Teegarden, Fairfield, OH (US); Gregory Dean Sunvold, Lewisburg, OH (US); Yen-Ping Chin Hsieh, Cincinnati, OH (US); Lee Ann Hagerty, Brookline, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/494,456

(22) Filed: Jun. 30, 2009

(51) Int. Cl. G06F 19/00; A01K 5/00; G06K 9/00; A61B 5/00; A23K 1/18

(52) U.S. Cl. 702/19; 119/51.01; 382/110; 426/2

(57) ABSTRACT

A method of assessing the eating experience of a companion animal. Further, a feeding device utilized in assessing the eating experience of a companion animal. Further, a method of modifying at least one attribute of a food product as a result of assessing the eating experience of a companion animal.

### FIELD OF THE INVENTION

The present invention relates generally to a method of assessing the eating experience of a companion animal. Further, the present invention relates to a feeding device utilized in assessing the eating experience of a companion animal. Further, the present invention relates to a method of modifying at least one attribute of a food product as a result of assessing the eating experience of a companion animal.

### BACKGROUND OF THE INVENTION

An increasing number of people are acquiring and caring for companion animals. Many companion animal owners, breeders and caregivers would like their companion animals to live longer and healthier lives. Management of diet and nutrition has drawn increasing amounts of attention as their importance has increased in regards to the overall well-being of companion animals. As a result, there has been an increase in the demand to assist owners, breeders and caregivers in setting and reaching dietary goals for their companion animals.

Simply setting dietary goals for a companion animal, however, is not enough in assisting the companion animal to maintain a balanced and healthy diet. Many factors affect whether a companion animal will consume a chosen diet. Such factors include, but are not limited to, palatability, prehension, ability to chew the food product, the aroma of the food product, and any other organoleptic or ergonomic-related factor. Food products that may be nutritionally balanced may not necessarily be palatable to the companion animal and, therefore, may remain uneaten for a lengthy period of time. Food products that are palatable to the companion animal but difficult for the animal to prehend may also remain uneaten by the companion animal.

Consumer testing is a common method of testing companion animal acceptance of a food product prior to placement of the food product in the marketplace. One method of consumer testing of a companion animal food product is to administer a questionnaire to the owner, breeder or caregiver of the companion animal to collect answers related to their perception of the eating experience of the companion animal during a feeding event. This may occur in conjunction with feeding a first food product and then a second food product to the companion animal while the owner, breeder or caregiver assesses which food product the companion animal prefers. This, however, is generally a measure of the owner, breeder or caregiver perception of the companion animal's eating experience rather than an assessment of the eating experience from the perspective of the companion animal. While the information collected from a questionnaire is important in the assessment of the eating experience of the companion animal, the sensitivity of assessing the companion animal's eating experience is greatly reduced when compared with a quantitative measurement of food consumption as well as visual images of the companion animal's behavioral response to a food product.

It would be desirable to provide a method of assessing the eating experience of a companion animal. It would be desirable to provide a feeding device to be utilized in assessing the eating experience of a companion animal. It would be desirable to provide a method of modifying an attribute of a food product as a result of assessing the eating experience of a companion animal.

### SUMMARY OF THE INVENTION

A method of assessing the eating experience of a companion animal, the method comprises the steps of providing a feeding device, the feeding device comprising a food product placement area, a weigh scale operatively associated with the food product placement area to weigh a food product placed on the food product placement area, a food product placement area image collector to collect image data of a behavioral response of the companion animal to the food product placed on the food product placement area; placing a food product on the food product placement area; collecting image data of the companion animal's behavioral response to the food product placed on the food product placement area; collecting consumption data; and correlating the image data with the consumption data to assess the eating experience of the companion animal.

A feeding device comprising a food product placement area; a weigh scale operatively associated with the food product placement area to weigh a food product placed on the food product placement area; a food product placement area image collector to obtain image data of a behavioral response of a companion animal to the food product placed on the food product placement area; and a detection device to indicate the presence of the companion animal at the feeding device.

A method of formulating a food product, the method comprising the steps of providing a feeding device, the feeding device comprising a food product placement area, a weigh scale operatively associated with the food product placement area to weigh a food product placed on the food product placement area, and an image collector to obtain image data of a behavioral response of a companion animal to the food product placed on the food product placement area; placing a food product on the food product placement area for consumption by the companion animal; collecting image data of the companion animal's behavioral response to the food product which has been placed on the food product placement area; collecting consumption data; correlating the image data with the consumption data to assess the eating experience of the companion animal; and utilizing the assessed eating experience of the companion animal to modify an attribute of the food product.

### BRIEF DESCRIPTION OF THE DRAWINGS

FIG. 1 illustrates a perspective view of an embodiment of a feeding device comprising one food product placement area.

FIG. 2 illustrates a perspective view of an embodiment of a feeding device comprising two food product placement areas.

FIG. 3 illustrates a perspective view of an embodiment of a feeding device comprising a food product placement area elevated above a weigh scale through the use of a food product placement area support.

FIG. 4 illustrates a perspective view of an embodiment of a feeding device located in an environment comprising environment image collectors.

FIG. 5 illustrates a top view of an embodiment of a feeding device.

### DETAILED DESCRIPTION OF THE INVENTION

### Definitions

As used herein, the term “behavioral response” refers to an outwardly perceivable action engaged in by a companion animal in response to being exposed to a food product and the attributes of the food product. The behavioral response may occur prior to, following, or during consumption of the food product. It should be noted that it is not necessary that consumption of the food product occur as a companion animal may behaviorally respond to a food product without consuming the food product. Non-limiting examples of behavioral responses include, the companion animal licks lips, looks up, shakes head, shakes ears, wags tail, sits down; the companion animal tail is down, tail is on floor, tail is up; the companion animal moves the food product out of a food product placement area; the companion animal consumes the food product from far side, front side, left side or right side of a food product placement area; the companion animal dribbles food product on the floor; the companion animal consumes the food product; the companion animal consumes the food product from far side, front side, left side or right side of a food receptacle; the companion animal explores the environment within which the feeding device is located; the companion animal gulps; the companion animal leaves the feeding device and returns to the feeding device; the companion animal makes sounds; the companion animal moves closer to the food product; the companion animal paws against the edge of a food product placement area; the companion animal paws against the edge of a food receptacle; the companion animal places a paw in the food product; the companion animal sniffs food product and walks away; and combinations thereof.

As used herein, the term “companion animal” refers to any animal for which an owner, breeder or caregiver controls the feeding habits. In an embodiment, a companion animal is an animal selected from the group consisting of dog, cat, rabbit, hamster, gerbil, ferret, and guinea pig. In an embodiment, a companion animal is a dog or a cat.

As used herein, the term “consumption data” refers to a quantitative measurement of consumption of a food product by a companion animal. It should be noted that it is not necessary that consumption of the food product occur. Thus, for example, the companion animal may choose to not consume the food product in a feeding event and the consumption data may reflect zero grams of food product consumed in that feeding event. Non-limiting examples of consumption data include, total amount of food product consumed in a given time period; total amount of food product consumed in a feeding event; average amount of food product consumed in multiple feeding events; duration of time companion animal is at the feeding device; number of feeding events in a given time period; rate of consumption; rate of consumption at first feeding event in a given time period; duration of time until first feeding event in a given time period; total duration of time the companion animal is at the feeding device in a given time period; and combinations thereof. Consumption data related to weight measurements is collected through the use of a weigh scale which collects weight measurements of a food product to which a companion animal has been exposed. Consumption data related to time measurements is collected through the use of any device determined to be suitable by one of ordinary skill in the art which can provide time information. Non-limiting examples of devices that can provide time information include watches, stopwatches and timers as well as those associated with an image collector such as a video recorder. In an embodiment, the consumption data may be imprinted onto a tangible medium such as, but not limited to, paper, computer software and memory devices.

As used herein, the term “feeding event” refers to a time period during which the companion animal is present at a feeding device as indicated by a detection device. It should be noted that a companion animal does not necessarily consume a food product in a feeding event. A companion animal may engage in multiple feeding events in a given time period.

As used herein, the term “food product” refers to a composition safe for consumption by a companion animal, such as, for example, a diet, supplement or treat. Non-limiting examples of a food product may include a diet (e.g., kibble), treat, biscuit, supplement, powder, or liquid such as, for example, a sauce or gravy. The food product may be nutritionally balanced. As used herein, the term “nutritionally balanced” means that the food product comprises the known required nutrients to sustain life in proper amounts and proportion based on recommendations of recognized authorities in the field of nutrition. The food product may be dry, semi-moist, or wet. A dry food product may have a moisture content of less than about 15% by weight of the food product. A semi-moist food product may have a moisture content from about 15% to about 70% by weight of the food product. A wet food product may have a moisture content greater than about 70% by weight of the food product. The food product comprises attributes that are physical, organoleptical and combinations thereof. Such attributes may be any attribute that can affect any of the senses of the companion animal such as sight, touch, taste, smell and sound. Such attributes may affect the prehension ability of the companion animal. Such attributes may affect the desire of the companion animal to consume the food product and the desire of the companion animal may be reflected in the eating experience of the companion animal. Attributes of a food product may include, but are not limited to, aroma, flavor, hardness, chewiness, shape, texture, color, size, pH and moisture level.

As used herein, the term “food receptacle” refers to any receptacle capable of holding a food product. For example, the food receptacle may be, but is not limited to, a bowl, plate, bucket, trough, bag, basin, cup, or bin. The food receptacle may be opaque, transparent or combinations thereof.

As used herein, the term “image collector” refers to a device that collects image data of the behavioral response of a companion animal following exposure to a food product. As used herein, the term “image data” refers to a collected visual image of the behavioral response of a companion animal following exposure to a food product. The image collector collects image data by capturing a visual image (e.g., taking a picture) of the behavioral response of the companion animal. In an embodiment, the visual image is imprinted onto a tangible medium such as photographic paper, filmstrip, digital medium, computer software, memory devices and combinations thereof. The image collector may be any device such as, but not limited to, camera, still frame camera, digital camera, movie camera, video camera, thermal sensor, infrared camera, fluoroscopic X-Ray imager, and digital media device. The image collector may comprise a wide-angle lens, a zoom lens, a pan-tilt lens, and combinations thereof. In an embodiment, the image collector collects image data in chronological order. In such an embodiment, the image collector may correlate a number or a time with the visual image to assist in maintaining the chronological order of the image data. In an embodiment, the image collector provides the visual image with a time, such as a time stamp, for when the visual image was collected. In an embodiment, the time may be indicated on a 12 hour or 24 hour clock. In an embodiment, the time may be a counter clock such as, for example, a counter clock starting at position 0.0.0:00 and counting upwards sequentially. In an embodiment, the image collector may provide a time and date for when the visual image was collected. Image data may be collected at any moment in time determined to be suitable by one of ordinary skill in the art. Non-limiting examples of moments in time when image data may be collected include prior to, during and/or after the exposure of a food product to a companion animal; prior to, during, and/or after consumption of the food product; from the moment the presence of a companion animal is indicated at the feeding device by a detection device until the presence of the companion animal is no longer indicated by the detection device; and combinations thereof. In an embodiment, the image collector may continuously collect image data. In an embodiment, the image collector may collect image data when the presence of a companion animal is indicated at the feeding device by a detection device. In an embodiment, the image collector is a food product placement area image collector. In an embodiment, the image collector is an environment image collector. The image collector (either the food product placement area image collector, the environment image collector, or both) collects image data to be utilized in the assessment of the eating experience of the companion animal.

Eating Experience:

The eating experience of a companion animal is the overall response of the companion animal to a food product (i.e., the desire, or lack thereof, to consume the food product and actual consumption, if any, of the food product) which manifests itself in a behavioral response, as reflected in image data, and a measurable response, as reflected in consumption data. Assessing the eating experience of a companion animal is a subjective assessment in which it is assessed whether the companion animal had a positive eating experience, a less than positive eating experience, or a negative eating experience. In an embodiment, the eating experience is assessed by an owner, breeder or caregiver of the companion animal. In an embodiment, the eating experience is assessed by one trained in animal behavior. In an embodiment, the eating experience is assessed by a veterinarian. In an embodiment, the eating experience is assessed by one conducting animal research. The eating experience can be assessed by exposing a companion animal to a food product, collecting image data of the companion animal's behavioral response to the food product, collecting consumption data, and correlating the image data with the consumption data.

The image data is correlated with the consumption data by time-wise pairing to assess the eating experience of the companion animal. By time-wise pairing the image data with the consumption data, an assessment may be made as to whether the companion animal had a positive eating experience, a less than positive eating experience, or a negative eating experience. For example, in an embodiment, the time-wise pairing will show the behavioral response prior to, during, and following consumption of a food product and the amount of food consumed and the length of time spent consuming the food product. In such an embodiment, the companion animal's behavioral response may indicate a desire to consume the food product and the consumption data may indicate that the food product was consumed which can, therefore, provide for an assessment that the companion animal desired the food product and the food product was consumed therefore providing for an assessment that the companion animal had a positive eating experience. Thus, in such an embodiment, it may be noted that the companion animal wanted to consume the food product and did consume the food product. As an example, in an embodiment, the companion animal's behavioral response may indicate a desire to consume the food product but the consumption data may indicate that not all or none of the food product was consumed which may provide for an assessment that the companion animal had a less than positive eating experience in that while the desire to consume the food product was present the companion animal did not consume any or all of the food product. Thus, in such an embodiment, it may be noted that the companion animal wanted to consume the food product but either did not like attributes of the food product, such as flavor or texture, or could not consume the food product due to attributes such as size or shape. As another example, in an embodiment, in the event that a companion animal chooses not to consume the food product, the time-wise pairing will show the behavioral response to the food product and the length of time the companion animal was present at the feeding device. In such an embodiment, the companion animal's behavioral response may indicate a lack of a desire to consume the food product and the consumption data may indicate that no food product was consumed therefore providing for an assessment that the companion animal had a negative eating experience. Thus, in such an embodiment, it may be noted that the companion animal did not want to consume the food product.

Feeding Device:

A feeding device is utilized to collect image data and consumption data for use in assessing the eating experience of a companion animal. The feeding device comprises a food product placement area, a food product placement area image collector, and a weigh scale operatively associated with at least a portion of the food product placement area. The feeding device may further comprise a detection device, a sound collector, a memory device or combinations thereof. In an embodiment, the feeding device is associated with hardware and software for the storage of image data and consumption data. The association may be through network interface or wireless connectivity. In an embodiment, the feeding device is portable and may comprise components such as handles or wheels to assist in the portability of the feeding device. Each component of the feeding device will be discussed in more detail below.

The feeding device comprises a food product placement area. As used herein, the term “food product placement area” refers to a designated area of the feeding device on which to place a food product for a companion animal and which is at least partially operatively associated with a weight scale of the feeding device. As the food product placement area is at least partially operatively associated with the weigh scale, the weigh scale can collect weight measurements of a food product placed thereon prior to, during, and following consumption, if any, by a companion animal. In an embodiment, the food product placement area is the uppermost horizontal surface of a weigh scale that is capable of recording the weight of a food product placed thereon. In an embodiment, the food product placement area is elevated above the weigh scale. In such an embodiment, a food product placement area support can be situated between the food product placement area and the weigh scale. The food product placement area support provides for association between the weigh scale and the food product placement area in order for the weigh scale to collect weight measurements of a food product placed upon the food product placement area. In an embodiment, the food product placement area is located below the weigh scale. In such an embodiment, the weigh scale may be, for example, a spring scale in which weight is measured by the distance a spring reflects under its load. In an embodiment, the food product placement area is cantilever to the weigh scale.

The food product placement area may be designated to a user of the feeding device through the use of indicators, such as, but not limited to, the written word, symbols, outlines, templates or combinations thereof. The indicators may assist in aligning the food product or a food receptacle holding a food product with the weight scale so that accurate weight measurements of the food product can be collected. For example, in an embodiment, written words such as “place food product here” or “place sample here” are written on the food product placement area. As an example, in an embodiment, symbols such as stars or bulls-eyes are used to indicate the food product placement area. As an example, in an embodiment, outlines such as an outline of a circle, square or rectangle are used to indicate the location of the food product placement area. In such an embodiment, the food product or a food receptacle holding the food product is placed within the outline. As an example, in an embodiment, a template is utilized to indicate the food product placement area. In such an embodiment, the template may be a sheet-like structure comprising a cut-out portion within which a food product or a food receptacle holding a food product is placed. The template may comprise at least one, two or three cut-out portions. A template comprising multiple cut-out portions may allow for side-by-side comparisons of food products and preference assessments, thereby, allowing for an assessment of a companion animal preference and an assessment of the eating experience of the companion animal regarding the multiple food products. In an embodiment in which side-by-side comparisons of food products is to occur, the feeding device may comprise a weigh scale at least partially operatively associated with the food product placement area of each food product to collect weight measurements of each food product. The template may be placed directly onto a surface of a weigh scale capable of weighing a food product. In an embodiment, the template may be elevated above the weigh scale and placed on a food product placement area support. In an embodiment, the template may be located on a surface of the feeding device and elevated above a weigh scale and a food product placement area support.

The feeding device comprises a weigh scale. As used herein, the term “weigh scale” refers to a device that measures the weight of a food product which has been placed on the food product placement area of a feeding device. Examples of weigh scales include, but are not limited to, spring scale, balance scale, beam balance, precision balance, cantilever beam system, analytical balance, strain gauge scale, and hydraulic or pneumatic scale. An example of a weigh scale is a Sartorius® scale model TE1502S 12VDC. The weigh scale is at least partially operatively associated with the food product placement area to collect weight measurements of a food product placed thereon. In an embodiment, the weigh scale is located below the food product placement area in order to collect the weight measurements. The uppermost horizontal surface of the weigh scale capable of collecting weight measurements may be designated as the food product placement area. In an embodiment, the weigh scale may be separated from the food product placement area by a food product placement area support that has elevated the food product placement area above the weigh scale. In an embodiment, the food product placement area is located below the weigh scale. In such an embodiment, the weigh scale may be, for example, a spring scale in which weight is measured by the distance a spring deflects under its load. In an embodiment, the food product placement area is cantilever to the weigh scale. The weigh scale collects weight measurements at moments in time determined to be appropriate by one of ordinary skill in the art. Non-limiting examples of when weight measurements can be collected include prior to, during or after placement of a food product on the food product placement area; prior to, during or after an initial feeding event by a companion animal; prior to, during or after any feeding event by a companion animal; and combinations thereof. In an embodiment, the weigh scale continuously collects weight measurements. In an embodiment, the weigh scale collects weight measurements when a companion animal is present at the feeding device as indicated by a detection device. In an embodiment, the weigh scale collects weight measurements when a companion animal is present at the feeding device as indicated by a detection device and continues to collect weight measurements for as long as the companion animal is indicated to be present at the feeding device.

In an embodiment, the feeding device comprises a weigh scale and a food product placement area at least partially operatively associated with the weigh scale. In an embodiment, the feeding device comprises two weigh scales and two food product placement areas, each at least partially operatively associated with one of the weigh scales. In an embodiment, the feeding device comprises a weigh scale and two food product placement areas at least partially operatively associated with the weigh scale. In such an embodiment, the two food product placement areas may be indicated by a template with two cut-out portions within which to place a food product.

The feeding device comprises a food product placement area image collector. The food product placement area image collector has as a primary subject the food product placement area of the feeding device. The food product placement area image collector may, therefore, collect visual images of the food product placement area and, depending on the type of lens utilized (e.g., wide angle) or the setting of the food product placement area image collector (e.g., zoom level), the environment surrounding the food product placement area. The food product placement area image collector may be located in the following non-limiting examples of locations on the feeding device—above the food product placement area, at an angle to the food product placement area and above the food product placement area, below the food product placement area, at an angle to the food product placement area and below the food product placement area, and combinations thereof. Non-limiting examples of a visual image that may be collected by a food product placement area image collector include the food product placement area, a food product placed on the food product placement area, a companion animal approaching the food product placement area, a companion animal consuming a food product placed on the food product placement area, the ability for the companion animal to prehend the food product and combinations thereof. In an embodiment in which the food product placement area image collector is located below the food product placement area, the food product placement area, the food product placement area support (if present), the template (if present) and the food receptacle (if present) are constructed from transparent materials. The use of transparent materials allows for visual images to be collected showing the companion animal consuming or attempting to consume the food product. In the event of unsuccessful attempts to consume the food product the visual images may illustrate whether the size and/or shape of the food product is problematic for the companion animal. In an embodiment, the feeding device comprises one food product placement area image collector. In an embodiment, the feeding device comprises two food product placement area image collectors. In an embodiment, the feeding device comprises from 1, 2, 3, or 4 to 6, 8 or 10 food product placement area image collectors.

In an embodiment, the environment surrounding the feeding device may comprise an environment image collector. The environment image collector has as a primary subject the feeding device. The environment image collector may, therefore, collect visual images of the feeding device and, depending on the type of lens utilized (e.g., wide angle) or the setting of the environment image collector (e.g., zoom level), the environment surrounding the feeding device. In an embodiment, the environment image collector is stationary within the environment. In an embodiment, the environment image collector is moveable and the location and/or positioning of the environment image collector may be altered within the environment. The environment image collector may be mounted such as on a tripod, a wall, or a movable beam extending from a wall. In such an embodiment, non-limiting examples of a visual image that may be collected by an environment image collector include the feeding device, a companion animal within the perimeter of the feeding device, and combinations thereof. In an embodiment, the environment surrounding the feeding device comprises at least one environment image collector. In an embodiment, the environment surrounding the feeding device comprises at least two environment image collectors. In an embodiment, the environment surrounding the feeding device comprises from 1, 2, 3 or 4 to 6, 8, or 10 environment image collectors.

In an embodiment, the feeding device comprises a detection device. As used herein, the term “detection device” refers to an apparatus that indicates the presence of a companion animal at the feeding device. The detection device may indicate the presence of a companion animal within a perimeter of the feeding device wherein the perimeter is of a size as desired by one of ordinary skill in the art. In an embodiment, the perimeter of the feeding device may be sized such that the companion animal is close enough to the feeding device to consume a food product located on the food product placement area. In an embodiment, the perimeter of the feeding device may be sized such that the companion animal is indicated as being present at the feeding device when the companion animal is within a few feet of the feeding device. Non-limiting examples of a detection device include RFID receiver, motion sensor, infrared beam, weight sensor, thermal sensor, and combinations thereof.

In an embodiment, the companion animal comprises an identifier which allows for identification of the companion animal. In such an embodiment, the companion animal can be identified whether the companion animal is alone in the environment or whether there are multiple companion animals within the environment surrounding the feeding device. Non-limiting examples of identifiers include names, collars, collar tags, ear tags, bar codes, hair coloration, hair patterns, infrared emissions, ultrasonic emissions, RF emissions, an identification transponder such as an RFID chip or global positioning system locator, and combinations thereof. In an embodiment, the companion animal's identifier is compatible with a detection device of the feeding device. For example, a companion animal may have an RFID chip attached to its collar or subcutaneously implanted into the companion animal, such as, between the shoulder blades of the companion animal. The feeding device can have a RFID receiver which can detect the RFID chip of the companion animal thereby indicating the presence of the companion animal within the perimeter of the feeding device as well as identifying the companion animal.

In an embodiment, the feeding device comprises a sound collector. As used herein, the term “sound collector” refers to a device that detects soundwaves. Non-limiting examples of soundwaves include those emitted from a companion animal such as, but not limited to, purring, barking, panting and whimpering; those emitted during the consumption of a food product such as, but not limited to, crunching, chewing, snapping, and popping; those originating in the environment such as, but not limited to, human noises and other companion animal noises, and sounds resulting from actions engaged in by a companion animal such as, for example, when a companion animal scratches a surface; and combinations thereof. A non-limiting example of a sound collector is a microphone. The sound collector may be positioned on the feeding device in any location determined to be suitable by one of ordinary skill in the art. Non-limiting examples of locations for the sound collector include locations in proximity to the weigh scale, the food product placement area, a food product placement area support, the food product placement area image collector, a template and combinations thereof.

In an embodiment, the feeding device comprises a memory device. As used herein, the term “memory device” refers to a device utilized for the storage of data such as, but not limited to, image data and consumption data. Non-limiting examples of a memory device include paper, filmstrip, video tape, digital medium, computer software, hard drives, flash drives, floppy disks, compact disks, and combinations thereof. In an embodiment, the memory device is removable and can be removed from the feeding device. In an embodiment, the memory device interacts with computer hardware or software as determined to be appropriate by one of ordinary skill.

The feeding device may be manufactured from any material determined to be suitable by one of ordinary skill in the art. The material utilized in the manufacture of the feeding device may be washable to allow for the cleaning of the feeding device. Such materials may include, but are not limited to, metal, wood, plexiglass, plastic, glass, polypropylene material, or any other suitable thermoplastic material such as polyethylene, polystyrene, acrylonitryl butadiene styrene (ABS), polyester, polyvinyl chloride, polycarbonate or elastomer, or a blend of these compounds, and combinations thereof.

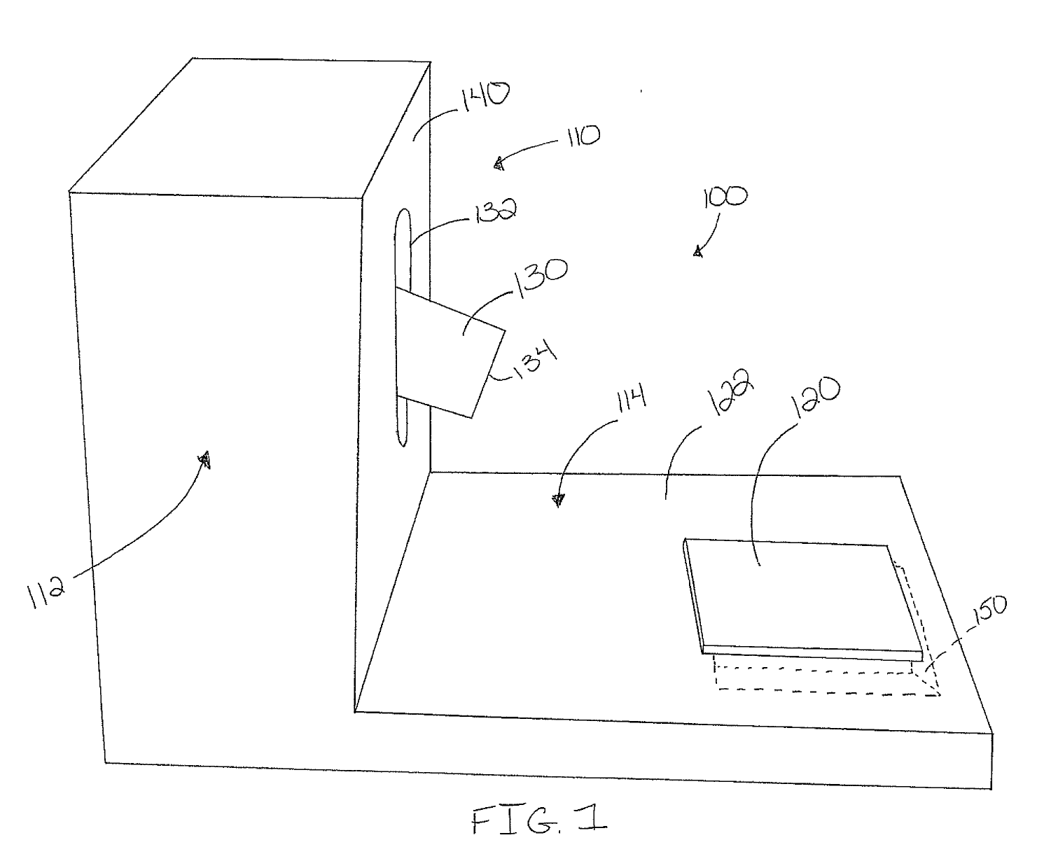

FIG. 1 is an illustration of a perspective view of an embodiment of a feeding device 100. Feeding device 100 comprises a housing unit 110 which comprises a vertical housing unit area 112 and a horizontal housing unit area 114. The housing unit 110 provides a three-dimensional area within which to enclose feeding device 100 components including an image collector 130 and a weigh scale 150 as well as any desired memory devices, hardware, software and connector cables as determined to be appropriate for the functionality of the feeding device 100. A food product placement area 120 is the uppermost surface of the weigh scale 150 capable of collecting weight measurements of a food product and is above the upper surface 122 of the horizontal housing unit area 114. It should be noted that while the food product placement area 120 is described as being above the upper surface 122 of the horizontal housing unit area 114, it should be realized that the food product placement area 120 could be positioned flush with or recessed below the upper surface 122 of the horizontal housing unit area 114. A food product placement area image collector 130 is illustrated as extending through an opening 132 in a forward facing surface 140 of the vertical housing unit area 112. It should be noted that the food product placement area image collector 130 could also be positioned such that the leading edge 134 of the food product placement area image collector 130 is flush with or recessed behind the opening 132 of the forward facing surface 140 of the vertical housing unit area 112.

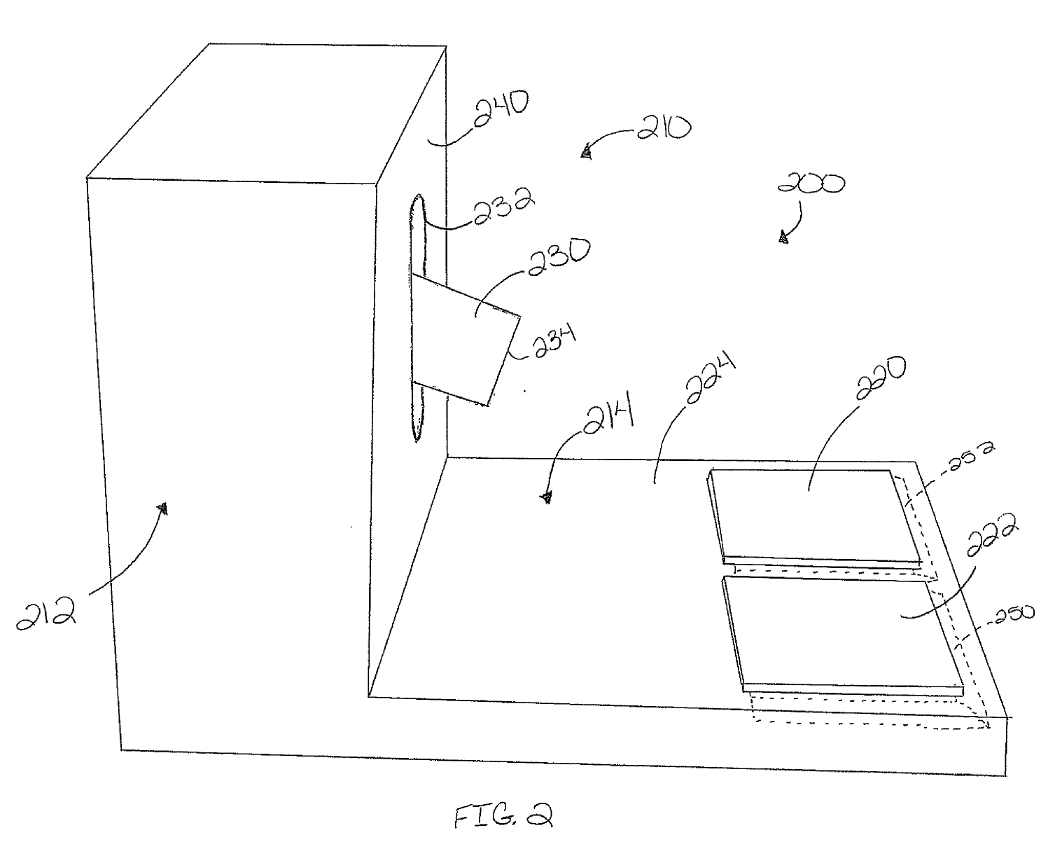

FIG. 2 is an illustration of a perspective view of an embodiment of a feeding device 200. Feeding device 200 comprises a housing unit 210 which comprises a vertical housing unit area 212 and a horizontal housing unit area 214. The housing unit 210 provides a three-dimensional area within which to enclose feeding device 200 components including an image collector 230 and weigh scales 250 and 252 as well as any desired memory devices, hardware, software and connector cables as determined to be appropriate for the functionality of the feeding device 200. Two food product placement areas, 220 and 222, are the uppermost surfaces of the weigh scales, 250 and 252, respectively, capable of collecting weight measurements of a food product and are above the upper surface 224 of the horizontal housing unit area 214. It should be noted that while the food product placement areas, 220 and 222, are described as being above the upper surface 224 of the horizontal housing unit area 214, it should be realized that the food product placement areas, 220 and 222, could be positioned flush with or recessed below the upper surface 224 of the horizontal housing unit area 214. A food product placement area image collector 230 is illustrated as extending through an opening 232 in a forward facing surface 240 of the vertical housing unit area 212. It should be noted that the food product placement area image collector 230 could also be positioned such that the leading edge 234 of the food product placement area image collector 230 is flush with or recessed behind the opening 232 of the forward facing surface 240 of the vertical housing unit area 212.

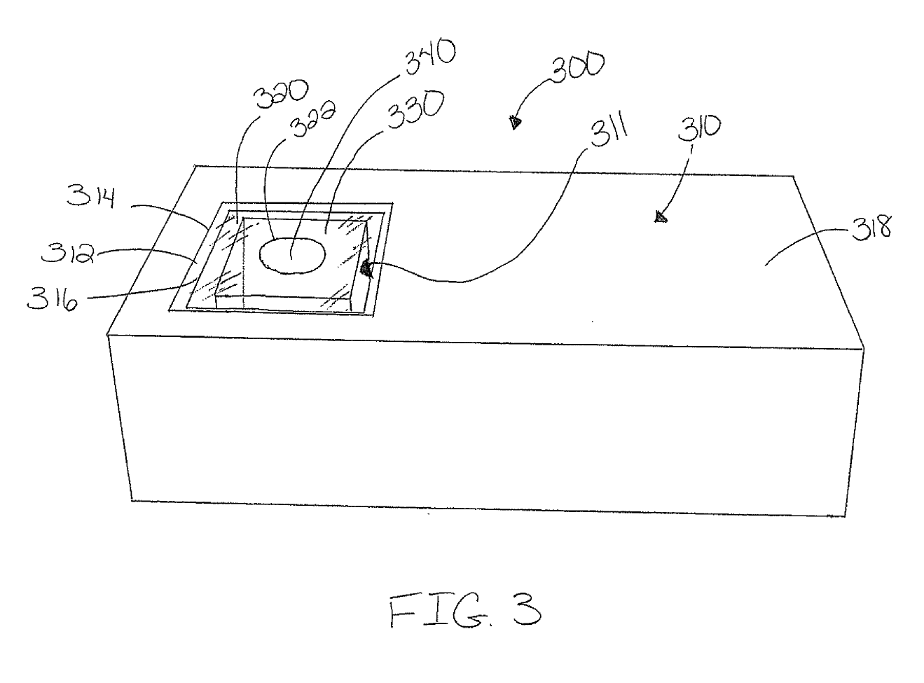

FIG. 3 is an illustration of a perspective view of an embodiment of a feeding device 300. Feeding device 300 comprises a housing unit 310 which provides a three-dimensional area within which to enclose feeding device components including a food product placement area support 330 and weigh scale (not shown) as well as any desired memory devices, hardware, software and connector cables as determined to be appropriate for the functionality of the feeding device 300. The upper surface 318 of the housing unit 310 comprises an opening 311. The opening 311 is bordered by a ledge 312 comprising an outer edge 314 and an inner edge 316. The ledge 312 provides support for a template 320. Template 320 comprises a cut-out portion 322 which defines a food product placement area 340. Below the template 320 is illustrated a food product placement area support 330 which can provide support for a food product placement area 340 which is elevated above a weigh scale (not shown).

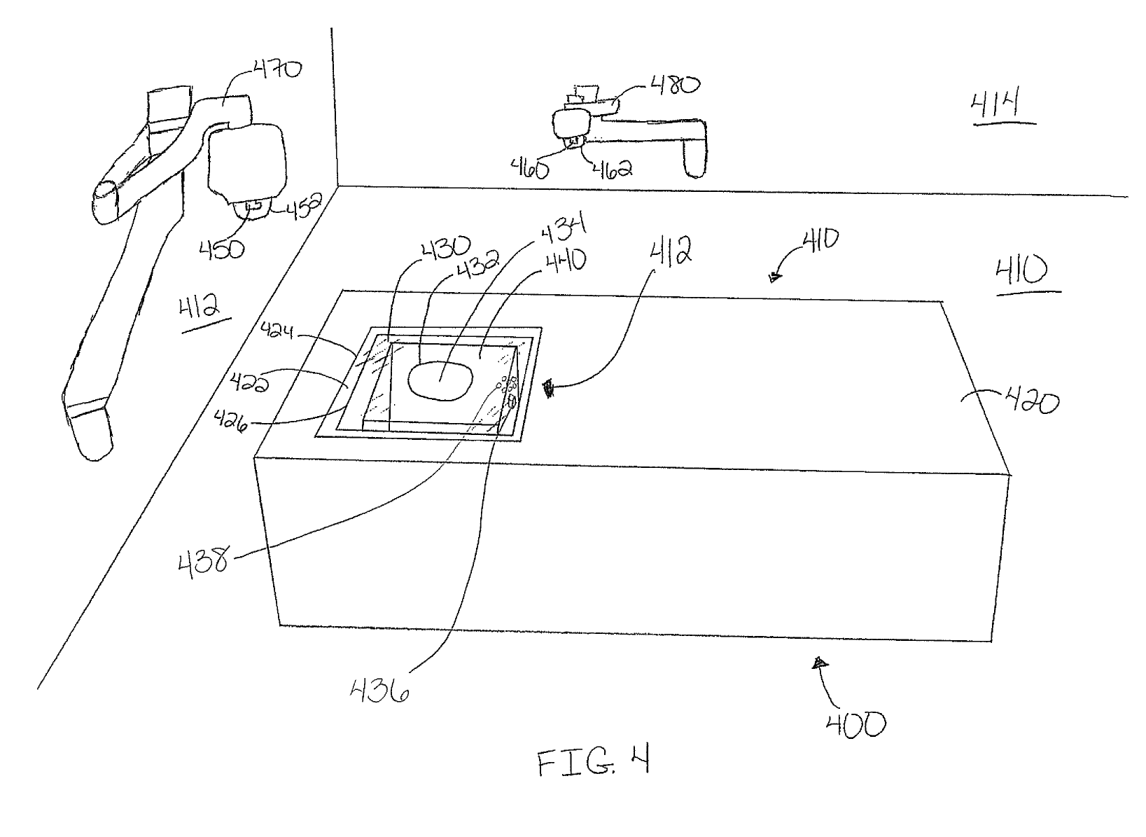

FIG. 4 is an illustration of a perspective view of an embodiment of a feeding device 400 located in an environment comprising environment image collectors, 450 and 460. Feeding device 400 comprises a housing unit 410 which provides a three-dimensional area within which to enclose feeding device components including a food product placement area support 440 and weigh scale (not shown) as well as any desired memory devices, hardware, software and connector cables as determined to be appropriate for the functionality of the feeding device 400. The upper surface 420 of the housing unit 410 comprises an opening 412. The opening 412 is bordered by a ledge 422 comprising an outer edge 424 and an inner edge 426. The ledge 422 provides support for a template 430. Template 430 comprises a cut-out portion 432 which defines a food product placement area 434. Below the template 430 is illustrated a food product placement area support 440 which can provide support for a food product placement area 434 which is elevated above a weigh scale (not shown). Below the template 430 is illustrated a sound collector 436. The sound collector 436, as illustrated, is in proximity with the food product placement area support 440. In an embodiment, such as illustrated, in which the sound collector 436 is positioned below the template 430, the template 430 has openings 438 therethrough to enable better detection by the sound collector of soundwaves. The feeding device 400 is illustrated as located in an environment comprising at least a floor 410 and walls 412 and 414. Environment image collectors, 450 and 460, are positioned on movable beams, 470 and 480, respectively, and the moveable beams, 470 and 480, are attached to walls, 412 and 414, respectively. The environment image collectors, 450 and 460, are illustrated as being encased within domes, 452 and 462, respectively. Domes 452 and 462 provide protection to the environment image collectors, 450 and 460, respectively, and help minimize any damage that may occur. Moveable beams, 470 and 480, are able to be positioned in any manner desired for collection of image data.

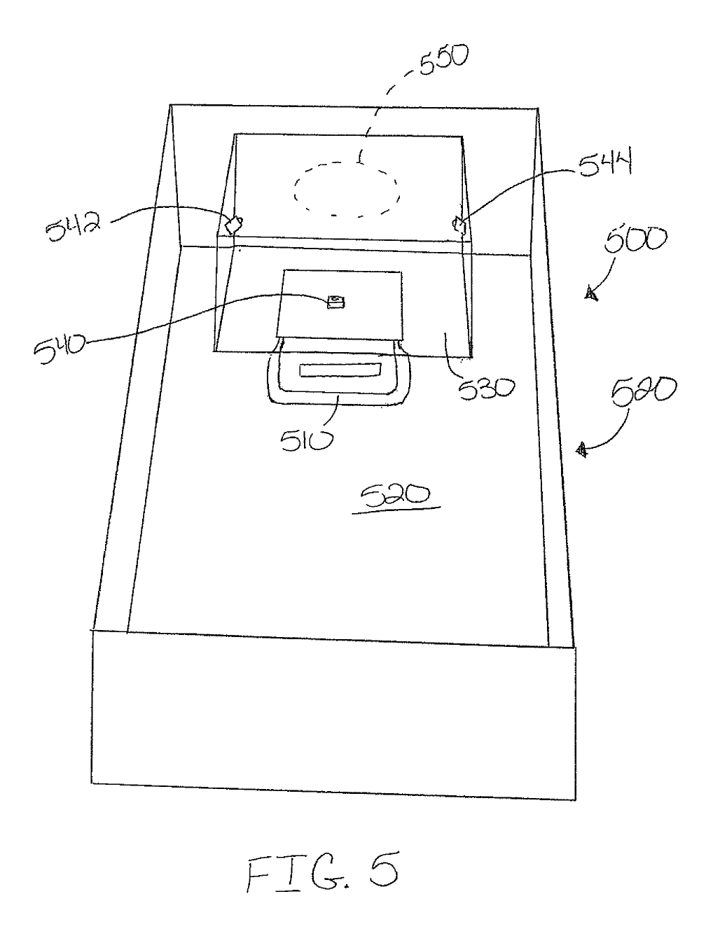

FIG. 5 is an illustration of a top view of an embodiment of a feeding device 500. Feeding device 500 comprises a housing unit 520 which provides a three-dimensional area within which to enclose feeding device components including a weigh scale 510, a food product placement area support 530, food product placement area image collectors, 540, 542 and 544 as well as any desired memory devices, hardware, software and connector cables as determined to be appropriate for the functionality of the feeding device 400. The weigh scale 510 is illustrated as positioned on the bottom surface 520 of the housing unit 520 of the feeding device 500. The food product placement area support 530 is positioned above the weigh scale 510 and provides support for a food product placement area 550. Food product placement area image collectors 540, 542 and 544 are illustrated as positioned within the food product placement area support 530. Food product placement area image collector 540 is positioned to be directly below and facing upwards towards the food product placement area 550. Food product placement area image collectors 542 and 544 are positioned to be at an angle below and facing towards the food product placement area 550. Food product placement area image collectors, such as 540, 542 and 544, positioned below a food product placement area, such as 550, can collect visual images of a companion animal prehending a food product.

Eating Experience Assessment:

The assessment of the eating experience of a companion animal may be conducted in any environment such as, but not limited to, a home, a veterinarian clinic, a research laboratory, a breeder environment, a kennel, a park, a mall or a public event such as a dog show or festival. At least one companion animal will be located within the environment wherein the feeding device is located and the companion animal may be allowed to move freely throughout the environment. Without being bound by theory, it is believed that free movement of the companion animal will allow for the companion animal to approach the feeding device in a natural feeding pattern of the companion animal. It is believed that a companion animal feeding in a natural feeding pattern will allow for the collection of image data and consumption data that more accurately reflects the eating experience of the companion animal. Free movement of the companion animal throughout the environment also allows for the companion animal to naturally experience the environment including interactions with an owner, breeder or caregiver, another companion animal, distractions such as, but not limited to, noises, petting, movement of another companion animal, movement of a human being, any activity that may affect the senses of the companion animal such as sight, sound, smell, taste, and touch, and combinations thereof that may exist in the environment. The experience and interactions with the environment may occur prior to, during or after a feeding event and may affect the eating experience of the companion animal.

As noted above, the assessment of the eating experience of the companion animal is a subjective assessment in which it is assessed whether the companion animal had a positive eating experience, a less than positive eating experience, or a negative eating experience. The eating experience can be assessed by exposing a companion animal to a food product, collecting image data, collecting consumption data, and correlating the image data with the consumption data as discussed above. In an embodiment, the assessment of the eating experience of the companion animal includes exposing the companion animal to two different food products and assessing the response of the companion animal to the two different food products in a side-by-side assessment.

In an embodiment, the assessment of the eating experience may begin with a review of the environment surrounding the feeding device, such as what type of environment the feeding device is in (e.g., home, veterinarian clinic, research laboratory, breeder environment, or kennel) and whether there are any distractions within the environment. The companion animal will be exposed to at least one food product. The exposure may occur by placing the food product onto the food product placement area of the feeding device or by allowing the companion animal to sniff the food product prior to placement of the food product on the food product placement area. The food product may be in a food receptacle, but it should be noted that the use of a food receptacle is not necessarily required. In an embodiment in which the eating experience of a companion animal will be assessed when presented with side-by-side food products, the exposure may be similar to as described above, the food products may be placed onto their respective food product placement areas or the companion animal may be allowed to sniff the food products either sequentially or at the same time prior to placement of the food products onto their respective food product placement areas. Following exposure of the food product to the companion animal, image data and consumption data may be collected for use in the assessment of the eating experience of the companion animal. As described above, the image data and the consumption data may be correlated with each other through time-wise pairing to assess whether the companion animal had a positive eating experience, a less than positive eating experience or a negative eating experience. In an embodiment in which the companion animal was exposed to more than one food product, the assessment can further include an assessment of whether the companion animal had a preference for a food product over the other food product to which it was exposed.

In an embodiment, the eating experience of a companion animal can be assessed by utilizing a feeding device to collect image data and consumption data and comparing the image data and consumption data to eating experience perception data collected from an eating experience perception questionnaire. As used herein, the term “eating experience perception questionnaire” refers to a list of questions provided to an owner, breeder or caregiver of a companion animal to elicit responses regarding the response of a companion animal to a food product from the perspective of the owner, breeder or caregiver of the companion animal. Such questions may include, but are not limited to, questions regarding general eating habits of the companion animal, general eating patterns of the companion animal, and questions regarding specific eating experiences of the companion animal such as a current eating experience or a previous eating experience. As used herein, the term “eating experience perception data” refers to the answers collected from an eating experience perception questionnaire. The eating experience perception questionnaire may inquire as to the perception of the owner, breeder or caregiver regarding the eating experience of the companion animal. During a feeding event, the owner, breeder or caregiver can observe the feeding event from the time the companion animal approaches the feeding device to the time the companion animal leaves the feeding device. The eating experience perception questionnaire may direct the owner, breeder or caregiver to make conclusions as to the companion animal's eating experience. In an embodiment in which a single food product is exposed to the companion animal, questions may relate to the approach of the companion animal to the feeding device, consumption, if any, of the food product, the perceived enjoyment of the food product, and combinations thereof. In an embodiment in which the companion animal is exposed to two food products, additional questions may be directed towards a preference assessment of which food product did the companion animal prefer. The eating experience perception conclusion may be compared with the eating experience assessment wherein the comparison may indicate whether the perception of the eating experience by the owner, breeder or caregiver is on par with the eating experience of the companion animal from the perspective of the companion animal. In an embodiment, the eating experience perception data obtained from the eating experience perception questionnaire in response to questions regarding a current eating experience or a previous eating experience may be correlated to the corresponding behavior data and the corresponding consumption data used in assessing the eating experience of the companion animal. Such a correlation may provide insight as to which behavior data and which consumption data is relevant to understanding consumer perception regarding the eating experience of the companion animal.

Modifying Attributes of a Food Product:

The assessment of the eating experience of the companion animal may be used to modify an attribute(s) of the food product. Thus, in the example described above in which the companion animal had a less than positive eating experience, the lack of consumption of the food product may be a result of the size or shape of the food product as the companion animal may have experienced difficulty in prehending the food product. The size and/or shape of the food product may be modified in an attempt to provide the companion animal with a positive eating experience. In the example described above in which the companion animal had a negative eating experience, the companion animal may have been offended by the aroma or color of the food product. The food product may be modified in an attempt to provide an aroma or color that would be more desirable to the companion animal for a positive eating experience. In an embodiment, more than one food product may be exposed to the companion animal in a side-by-side preference assessment. In such a preference assessment the food products may be the same for all but a single attribute. The assessment of the eating experience of the companion animal may include an assessment as to which food product the companion animal demonstrated a preference for. For example, a companion animal may be exposed to two food products which are different from each other in their aroma. The assessment of the eating experience of the companion animal may include an assessment as to whether the companion animal demonstrated a preference for one aroma over the other aroma.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of assessing the eating experience of a companion animal, the method comprising the steps of:
a. providing a feeding device, the feeding device comprising:
i. a food product placement area;
ii. a weigh scale operatively associated with the food product placement area to weigh a food product placed on the food product placement area;
iii. a food product placement area image collector to collect image data of a behavioral response of the companion animal to the food product placed on the food product placement area;
b. placing a food product on the food product placement area;
c. collecting image data of the companion animal's behavioral response to the food product placed on the food product placement area;
d. collecting consumption data; and
e. correlating the image data with the consumption data to assess the eating experience of the companion animal.

2. The method of claim 1 wherein the food product is placed into a food receptacle and the food receptacle containing the food product is placed on the food product placement area.

3. The method of claim 2 wherein the food receptacle is transparent.

4. The method of claim 1 wherein the assessment of the eating experience of the companion animal is conducted in an environment selected from the group consisting of a home, a veterinarian clinic, a research laboratory, a breeder environment, or a kennel.

5. The method of claim 4 wherein the assessment of the eating experience of the companion animal is conducted at home.

6. The method of claim 4 wherein the environment comprises an environment image collector.

7. The method of claim 1 further comprising a step of administering an eating experience perception questionnaire to an owner, breeder or caregiver of the companion animal and collecting eating experience perception data from the eating experience perception questionnaire.

8. The method of claim 7 further comprising a step of comparing the eating experience perception conclusion to the assessment of the eating experience of the companion animal.

9. The method of claim 1 wherein the feeding device further comprises a sound collector.

10. The method of claim 1 wherein the feeding device further comprises a detection device.

11. A feeding device comprising:
a. a food product placement area;
b. a weigh scale operatively associated with the food product placement area to weigh a food product placed on the food product placement area;
c. a food product placement area image collector to obtain image data of a behavioral response of a companion animal to the food product placed on the food product placement area; and
d. a detection device to indicate the presence of the companion animal at the feeding device.

12. The feeding device of claim 11 further comprising a sound collector.

13. The feeding device of claim 11 further comprising a second food product placement area and a second weigh scale operatively associated with the second food product placement area to weigh a second food product placed on the second food product placement area.

14. A method of formulating a food product, the method comprising the steps of:
a. providing a feeding device, the feeding device comprising:
i. a food product placement area;
ii. a weigh scale operatively associated with the food product placement area to weigh a food product placed on the food product placement area;
iii. an image collector to obtain image data of a behavioral response of a companion animal to the food product placed on the food product placement area;
b. placing a food product on the food product placement area for consumption by the companion animal;
c. collecting image data of the companion animal's behavioral response to the food product which has been placed on the food product placement area;
d. collecting consumption data;
e. correlating the image data with the consumption data to assess the eating experience of the companion animal; and
f. utilizing the assessed eating experience of the companion animal to modify an attribute of the food product.

15. The method of claim 14 wherein the attribute is selected from the group consisting of aroma, taste, sound, chewiness, shape, texture, color, size, moisture level and combinations thereof.

16. The method of claim 14 further comprising a step of administering an eating experience perception questionnaire to an owner, breeder or caregiver of the companion animal and collecting eating experience perception data from the eating experience perception questionnaire.

17. The method of claim 16 further comprising the step of comparing the eating experience perception conclusion to the assessment of the eating experience of the companion animal.
